(19) United States
(12) Patent Application Publication
(10) Pub. No.: US 2018/0317196 A1
(43) Pub. Date: Nov. 1, 2018

(54) ADAPTIVE WAKE-UP SCHEDULING UNDER PRS MUTING

(71) Applicant: QUALCOMM Incorporated, San Diego, CA (US)

(72) Inventors: Ju-Yong Do, Cupertino, CA (US); Guttorm Opshaug, Redwood City, CA (US)

(21) Appl. No.: 15/581,111

(22) Filed: Apr. 28, 2017

(51) Int. Cl. H04W 64/00; H04W 24/08; H04W 24/10

(52) U.S. Cl. CPC H04W 64/00; H04W 24/10; H04W 24/08

(57) ABSTRACT

Systems, methods, apparatuses, and computer-readable media for adaptive wake-up scheduling under PRS muting are disclosed. For example, A mobile device can measure a plurality of reference signals for positioning having a muting pattern cycle comprising two or more time periods. The mobile device, during an evaluation phase, can receive during one or more evaluation time periods within the muting pattern cycle, reference signals detectable by the mobile device during the one or more evaluation time periods within the muting pattern cycle. The mobile device can determine a subset of the muting pattern cycle for measuring reference signals, where the subset of the muting pattern cycle comprises a number of time periods fewer than the two or more time periods of the muting pattern cycle. The mobile device then measures reference signals only during the determined subset of the muting pattern cycle.

### CROSS-REFERENCE TO RELATED APPLICATIONS

This application is related to co-pending U.S. patent application Ser. No. ______, titled “Adaptive Wake-Up Scheduling Under PRS Muting,” filed Apr. 28, 2017, and having Attorney Docket No. 093495/1030619 (164780U2), the entirety of which is hereby incorporated by reference.

### BACKGROUND

Mobile devices are frequently equipped with sensors that can be used to determine its location. For example, many mobile devices are equipped with a Global Navigation Satellite System (“GNSS”) receiver, such as a Global Position System (“GPS”) receiver. Mobile devices may also determine their locations using techniques to detect a distance to a nearby cellular transmitter, such as using the observed time-difference of arrival (“OTDOA”) technique, and provide such information to a network device, which calculates the mobile device's location and transmits the location to the mobile device. To obtain high-quality positioning based on such cellular techniques, a mobile device may obtain OTDOA measurements from a large number of nearby cellular transmitters over a period of time, which can result in significant power usage.

### BRIEF SUMMARY

Various examples are described for adaptive wake-up scheduling under PRS muting. For example, one example method for measuring a plurality of reference signals for positioning that have a muting pattern cycle comprising two or more time periods by a mobile device includes receiving, by the mobile device, during one or more evaluation time periods within a muting pattern cycle, reference signals detectable by the mobile device during the one or more evaluation time periods within the muting pattern cycle; determining a subset of the muting pattern cycle for measuring reference signals, wherein the subset of the muting pattern cycle comprises a number of time periods fewer than the two or more time periods of the muting pattern cycle; and measuring, by the mobile device, reference signals only during the determined subset of the muting pattern cycle.

One example device for measuring a plurality of reference signals for positioning having a muting pattern cycle comprising two or more timeslots includes a non-transitory computer-readable medium storing processor-executable instructions; a processor in communication with the non-transitory computer-readable medium, the processor configured to execute the processor-executable program code to: receive, by a mobile device, during one or more evaluation time periods within a muting pattern cycle having two or more time periods, reference signals detectable by the mobile device during the one or more evaluation time periods within the muting pattern cycle; determine a subset of the muting pattern cycle for measuring reference signals, wherein the subset of the muting pattern cycle comprises a number of time periods fewer than the two or more time periods of the muting pattern cycle; and measuring, by the mobile device, reference signals only during the determined subset of the muting cycle

An example apparatus for measuring a plurality of reference signals for positioning having a muting pattern cycle comprising two or more timeslots includes means for receiving, during one or more evaluation time periods within a muting pattern cycle, reference signals detectable by the mobile device during the one or more evaluation time periods of the set of time periods within the muting pattern cycle; means for determining a subset of the muting pattern cycle for measuring reference signals, wherein the subset of the muting pattern cycle comprises a number of time periods fewer than the two or more time periods of the muting pattern cycle; and means for measuring reference signals only during the determined subset of the muting pattern cycle.

An example non-transitory computer-readable medium storing processor-executable instructions configured to cause a processor to receive, by a mobile device, during one or more time evaluation periods within a muting pattern cycle having two or more time periods, reference signals detectable by the mobile device during the one or more time evaluation periods within the muting pattern cycle; determine a subset of the muting pattern cycle for measuring reference signals, wherein the subset of the muting pattern cycle comprises a number of time periods fewer than the two or more time periods of the muting pattern cycle; and measure, by the mobile device, reference signals only during the determined subset of the muting pattern cycle.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example environment for adaptive wake-up scheduling under PRS muting;

FIGS. 2A-2B show example PRS muting cycles;

FIG. 3 shows an example system for adaptive wake-up scheduling under PRS muting;

FIG. 4 shows an example mobile device adaptive wake-up scheduling under PRS muting;

FIGS. 5-6 show example methods for adaptive wake-up scheduling under PRS muting; and

FIG. 7 shows an example wake-up schedule for adaptive wake-up scheduling under PRS muting.

### DETAILED DESCRIPTION

Examples are described herein in the context of adaptive wake-up scheduling under positioning reference signal (“PRS”) muting. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

In one illustrative example, a user of a mobile device turns on her mobile device. After the mobile device powers up, it begins to search for cellular transmitters in a cellular network that may be usable for providing reference signals for determining the mobile device's location using OTDOA. In this example, the cellular transmitters are configured to periodically transmit position reference signals (“PRS”), and each cellular transmitter is assigned to one (or more) of a number of available time periods within a repeating cycle. When a cellular transmitter's time period occurs, it transmits its PRS; otherwise, it does not transmit a PRS, which is generally referred to as PRS “muting.” Each cycle may be referred to as a PRS muting cycle.

To use these position reference signals, the mobile device must activate its receiver at the appropriate times, based on which cellular transmitter's PRS it is configured to receive. However, since at any given time, the mobile device may be within range of a number of cellular transmitters, and because multiple PRSs are needed to accurately determine its location, the mobile device must “wake up” during multiple time periods to receive PRS from different cellular transmitters. However, because some receive PRS will be of better quality than others, e.g., due to range to a transmitter, weather, multi-path effects, etc., the mobile device may need to select which time periods to “wake up” for, and which to “sleep” through.

The mobile device is configured to identify cellular transmitters to use for location in two ways. In the first example, the mobile device accesses its cell list to identify nearby cellular transmitters and to identify time periods during which they transmit PRS. In this example, the mobile device identifies the ten nearby cellular transmitters having the best signal-to-noise ratio, and wakes up during the corresponding time period of the PRS muting cycle and receives the PRS. After receiving a PRS from each selected transmitter, it evaluates the quality of the received PRS. If the quality is sufficiently high, the cellular transmitter is marked as a “valid” PRS source; otherwise, the cellular transmitter is indicated as having a “failed” PRS and may be struck from the list, or may be retried one or more times. The mobile phone may continue this process until a sufficient number of valid PRS sources are identified, or until all nearby cells have been marked as valid or failed.

In another example, rather than measuring the cells itself, the mobile device may send a request for assistance data to a PRS assistance system for information about PRS sources. The mobile device may then receive assistance data identifying cells, the corresponding time periods in the PRS muting cycle, and respective quality of PRS from each identified cell.

The user then activates an application on her mobile device to find a nearby coffee shop. The application, after launching, requests location information from the mobile device's positioning system and indicates a need for low precision location information, e.g., within 50 meters. The mobile device's positioning system receives the request and initiates a location function to determine the mobile device's location. In this case, the mobile device first determines a number of PRS sources appropriate based on the application's location precision target. Based on the low precision target, the mobile device determines that four PRS sources will be sufficient, and selects four PRS sources having high quality PRS reference signals. The mobile device then determines the corresponding time periods within the PRS muting cycle and wakes up at the appropriate times to receive the PRS. After receiving the PRSs, the positioning system performs measurements on the received PRSs and provides the measurements to a remote cellular network device, which determines the mobile device's location and transmits the determined location to the mobile device.

Later, the user witnesses a car accident and dials 911. The telephone application detects the 911 call and transmits a request to the mobile device's positioning system for a location and indicates a need for the highest possible precision location information. The positioning system then determines that as many PRS sources should be used as possible and selects all PRS sources that are marked “valid.” The mobile device then wakes up at each time period corresponding to one (or more) of the selected PRS sources, or the mobile device simply wakes up for every time period to receive all available PRS. The mobile device them performs measurements on the received PRS information and provides them to a cellular network device, which again determines the mobile device's location and provides it to the mobile device, which then transmits the location to an E911 server.

This illustrative example is given to introduce the reader to the general subject matter discussed herein and the disclosure is not limited to this example. The following sections describe various additional non-limiting examples and examples of systems and methods for adaptive wake-up scheduling under PRS muting.

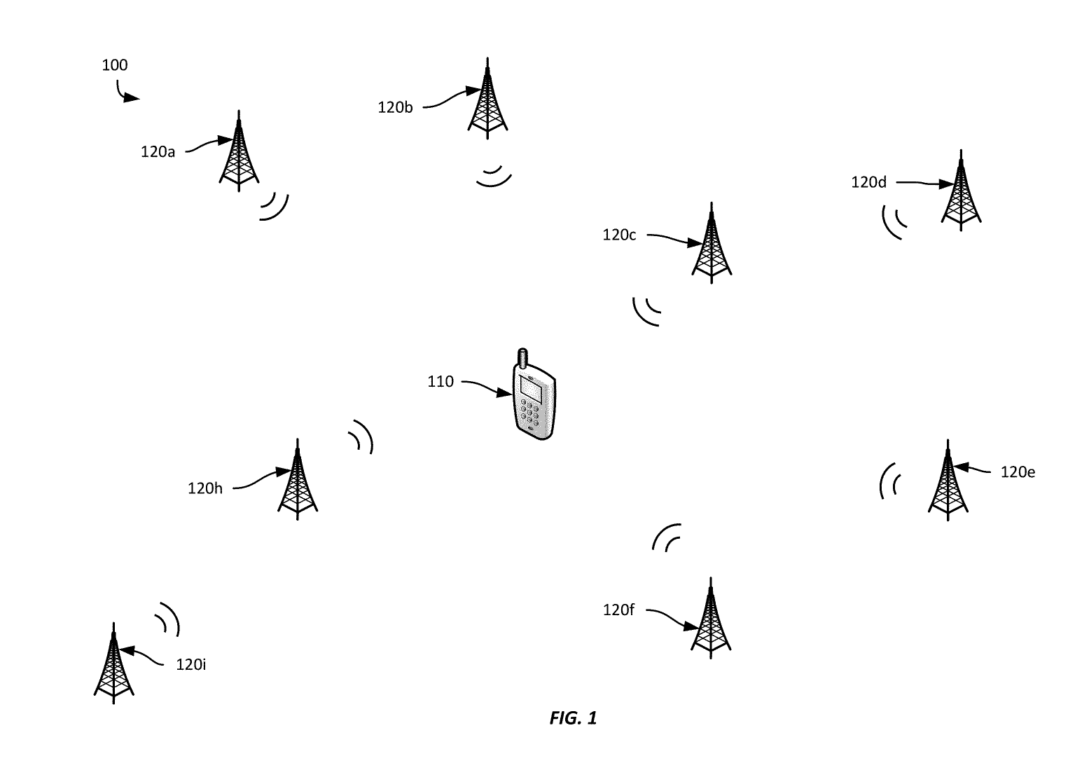

Referring now to FIG. 1, FIG. 1 shows an example environment 100 having a mobile device 110 and a number of cellular transmitters 120a, 120b, 120c, 120d, 120e, 120f, 120g, 120h, and 120i, which may each also be referred to as a PRS source, at various locations in proximity to the mobile device 110. As can be seen, the various cellular transmitters 120a-i are located at different distances and directions with respect to the mobile device 110. Thus, when each cellular transmitter 120a-i transmits at its PRS time period, the respective PRSs received by the mobile device 110 will likely have different characteristics that may affect the quality of the PRS.

In the context of the example environment, each cellular transmitter 120a-i transmits a 3^{rd} Generation Partnership Project (“3GPP”) Long-Term Evolution (“LTE”) PRS, which comprises a pseudo-random quadrature phase shift keying (“QPSK”) sequence. In another example, other PRS may be employed and may not be specifically dedicated to providing a signal for use in determining a mobile device's location. In this example, each cellular transmitter's PRS will differ based on the transmitting cell's identity.

In this example, the mobile device 110 is configured to receive PRS broadcast by the various cellular transmitters 120a-i; however, based on targets for position accuracy indicated by a software application, the mobile device 110 may only receive PRS from certain cells. For example, to reduce power consumption, the mobile device 110 may “sleep” through PRS broadcast from some cellular transmitters, while it may “wake up” in time to receive PRS broadcast from other cellular transmitters. In general, the more PRS the mobile device 110 receives, the more accurately its position may be calculated. However, for many applications, highly-accurate position information is not required. For example, a mobile application that locates nearby restaurants may have more relaxed targets for location accuracy than other applications, such as emergency, e.g., E911, applications or even navigation applications. Thus, based on the accuracy needs of a requesting application, the mobile device 110 may be able to sleep through more PRS broadcasts rather than expending battery power to wake up, receive, and process all (or even a significant majority) of PRS broadcasts.

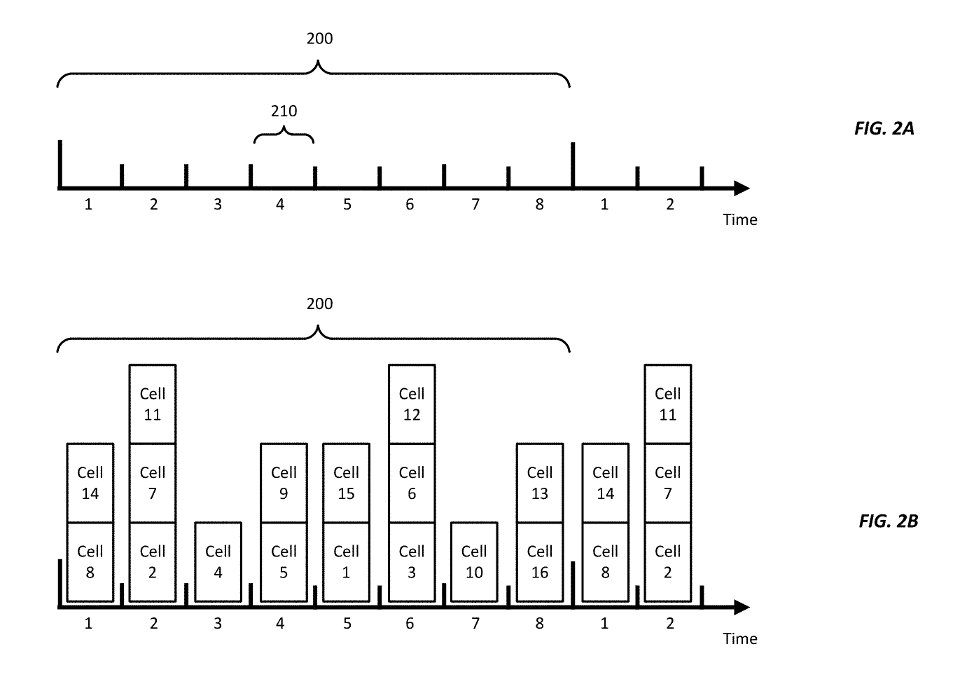

Referring now to FIG. 2A, FIG. 2A illustrates an example of a PRS muting cycle 200 which has multiple time periods 210. In this example, the PRS muting cycle 200 has 8 time periods 210, numbered 1-8; however, other numbers of time periods may be used, typically between 1 and 16 time periods per PRS muting cycle. In this example, each time period is 160 milliseconds (“ms”), resulting in a PRS muting cycle with a period of 1280 ms. Other time periods may be employed instead, including 320 ms, 640 ms, and 1280 ms in different examples. Thus, any suitable number of time periods and durations may be employed.

FIG. 2B shows the PRS muting cycle 200 of FIG. 2A as well as cellular transmitter assignments within the PRS muting cycle 200, referred to as “cells” in the Figure. As can be seen 16 different cells are represented, with each assigned to one of the 8 time periods. Further, each time period may be assigned to multiple individual cells. For example, time period 1 is assigned to cells 8 and 14. As each new time period arrives, the assigned cells broadcast their respective PRS for the duration of the time period, which mobile devices can then receive.

When the last time period of the then-current PRS muting cycle 200 ends, the next PRS muting cycle begins. As can be seen in FIG. 2B, after time period 8 of PRS muting cycle 200, time period 1 of the next PRS muting cycle begins and cells 8 and 14 again broadcast their respective PRS. With knowledge of a PRS muting cycle and nearby cellular transmitter, a mobile device can selectively wake-up and listen for PRS from individual cellular transmitters, thereby potentially saving power over examples that simply listen to all available PRS time periods within a PRS muting cycle.

In instances where less-accurate position information is adequate, to determine which PRS broadcasts to receive, the mobile device 110 may obtain measurements about the quality of various available PRS within the PRS muting cycle at the mobile device's location, referred to as a PRS evaluation scan. The mobile device may perform these measurements periodically, e.g., every 5 minutes, or after a particular event occurs, such as a handoff to a new cellular transmitter or after the mobile device powers-on and boots. The quality of the received PRS may be determined and used to assign scores or ranks to one corresponding cellular transmitters or may be used to eliminate one or more cellular transmitters from consideration for a period of time, e.g., until the next PRS evaluation scan.

After determining the respective quality of each received PRS, the mobile device 110 may then determine how many PRSs are appropriate for a given position accuracy, select cellular transmitters having acceptable PRS quality, and select one or more time periods during which to wake up and receive PRS from the selected cellular transmitters. In some examples, as will be discussed in more detail below, the mobile device 110 may select the N cellular transmitters having the highest measured PRS quality, where N is a number of PRS associated with a requested position accuracy. In other examples, however, the mobile device 110 may select cellular transmitters having high-quality PRS, but that tend to overlap in the same time periods, which may reduce the number of time periods during which the mobile device 110 must wake up.

In some examples, rather than measuring PRS quality, the mobile device may receive PRS assistance data that includes PRS quality information based on the mobile device's estimated position, e.g., based on the cellular transmitter it is communicating with or a location provided by the mobile device. The assistance data, in some examples, may include an identification of cellular transmitters broadcasting PRS during a PRS muting cycle, time periods within the PRS muting cycle associated with one or more of the cellular transmitters, quality information associated with one or more of the cellular transmitters, as well as information about the PRS muting cycle, e.g., a number of time periods and a duration of each time period.

In an example where the mobile device 110 receives PRS assistance data from an assistance server, the mobile device 110 may accept the PRS assistance data and select cellular transmitters based on the received PRS assistance data. In some examples, however, the mobile device 110 may perform a PRS evaluation scan and provide the results of the PRS evaluation scan to the assistance server.

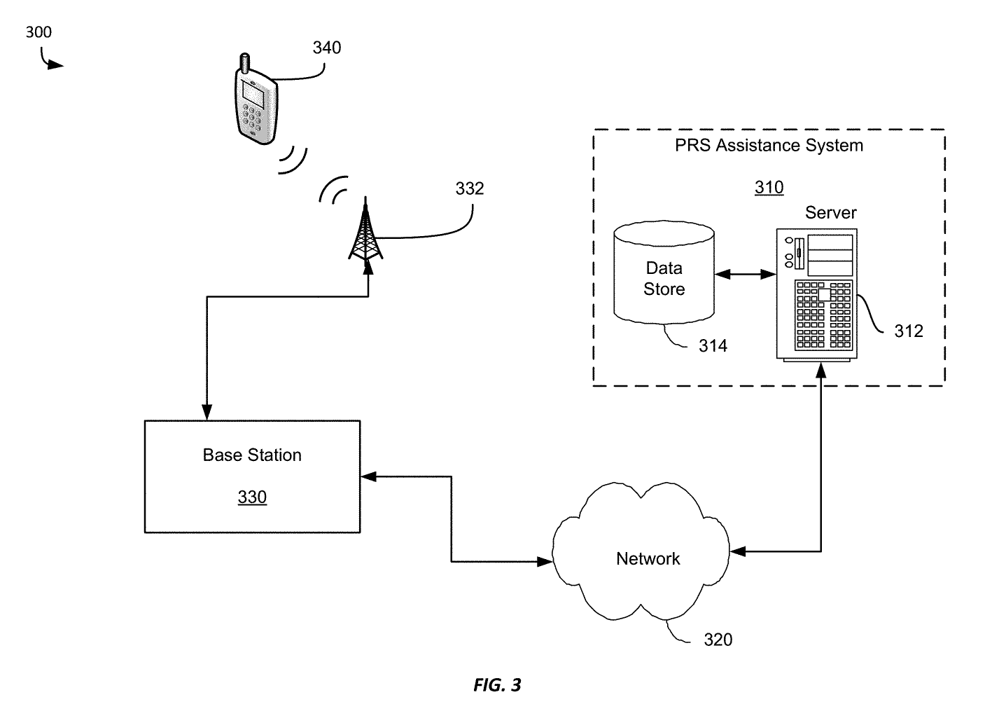

Referring now to FIG. 3, FIG. 3 shows an example system 300 for adaptive wake-up scheduling under PRS muting. The system 300 includes a PRS assistance system 310, which is in communication with a mobile device 340 via a network 320, a base station 330, e.g., an eNodeB in an LTE network, and a cellular transmitter 332. The PRS assistance system 310, which includes one or more servers 312 in communication with one or more data stores 314 in this example, and is configured to receive requests for PRS assistance data from the mobile device 340 and to respond to the requests with PRS assistance data. In some examples, however, the PRS assistance system 310 may provide unsolicited PRS assistance data to the mobile device 340, e.g., when the mobile device 340 powers-up and connects to a cellular network, after handoff to a new eNodeB, etc.

In some examples, PRS assistance data provided by the PRS assistance system 310 may be crowdsourced. For example, mobile devices operated by customers of a cellular network provider may provide PRS measurement information and associated location information to the PRS assistance system 310. The PRS assistance system 310 may then catalog and store the PRS measurement information in the data store, e.g., in a relational or object-oriented database, in a way that it is associated with the location information. At a later time, server(s) 312 of the PRS assistance system 310 may query the data store(s) 314 by providing a location for which PRS assistance data is requested. The data store(s) 314 may respond with one or more database records having PRS measurement information associated with the provided location.

In some examples, the PRS assistance system 310 may store each newly-received report of PRS measurement information in the data store(s) 314 as a new record. In one such example system, each new record is associated with a time stamp and the PRS assistance system 310 periodically purges data records older than a threshold age. For example, the PRS assistance system 310 may purge data records older than 30 days or 6 months. However, in some examples, rather than storing each new record, new measurement data may be integrated with existing measurement data. Integrating new measurements with existing measurement data may involve averaging the existing data with the new measurements, such as a weighted average, or may involve maintaining a history of the most recent N measurements, deleting the oldest of those measurements, and computing a new average with the prior N−1 measurement data and the new measurement data. Still further examples for incorporating new PRS measurement information into the data store(s) 314 may be employed according to this disclosure.

In this example, the PRS assistance system 310 provides PRS assistance data to the mobile device 340 that is not based on crowdsourced information, but instead includes identities of cellular transmitters, respective assignments within a PRS muting cycle, and information about the time periods within the PRS muting cycle, e.g., durations and number of time periods. Further, the PRS assistance system 310, in some examples, may provide other information, such as specific assignments of cellular transmitters or time periods to use for location determination at varying levels of precision.

For example, the PRS assistance system 310 may provide PRS assistance data that identifies the number and identities of cellular transmitters to use for low accuracy, medium accuracy, high accuracy, and highest accuracy location determinations. In one example, the PRS assistance data may identify three cellular transmitters to use for low accuracy location determination, five cellular transmitters to use for medium accuracy location determination, twelve cellular transmitters to use for high-accuracy location determination, and sixteen cellular transmitters to use for highest-accuracy location determination. The mobile device 340 may then, based on a given or requested level of accuracy, select the corresponding cellular transmitters based on the received PRS assistance data. And while four levels of accuracy are described above, any suitable number of accuracy levels may be employed as well as any suitable number of cellular transmitters per accuracy level may be employed in different examples.

Further, while the examples above discuss location accuracy targets, the PRS assistance data may provide the number and identities of cellular transmitters to use based on a desired rate of power consumption during location determination using PRS. For example, the PRS assistance data may include numbers and identities of cellular transmitters to use for low power consumption, medium power consumption, high power consumption, and highest power consumption. Further, the PRS assistance data may include two different sets of information—one related to location accuracy and one related to rates of power consumption. Thus, depending on a power or accuracy target at the mobile device 400, the mobile device 400 may select one or more of the sets of information provided within the PRS assistance data.

For example, if a configuration or target for low power consumption is detected, despite a need for high location accuracy, the mobile device 400 may ignore the power consumption configuration in favor of location accuracy. Alternatively, the mobile device 400 may reduce a location accuracy below the requested location accuracy. Or in some examples, e.g., in an emergency scenario, the mobile device 400 may override a power consumption configuration in favor of obtaining the highest-positional accuracy. To make such determinations, the mobile device 400 may be configured with one or more rules to resolve conflicts between power consumption configurations and location accuracy. In some examples, the mobile device 400 may select a location accuracy having the fewest number of time periods during which to wake up, or the mobile device may select the location accuracy having the greatest number of time periods during which to wake up. In some examples, the mobile device may select an intermediate number of time periods during which to wake up. For example, if a power consumption configuration of the lowest power configuration is received along with a high degree of location accuracy, the mobile device 400 may select a number of cellular transmitters associated with a medium degree of location accuracy. Still further variations may be employed according to other examples.

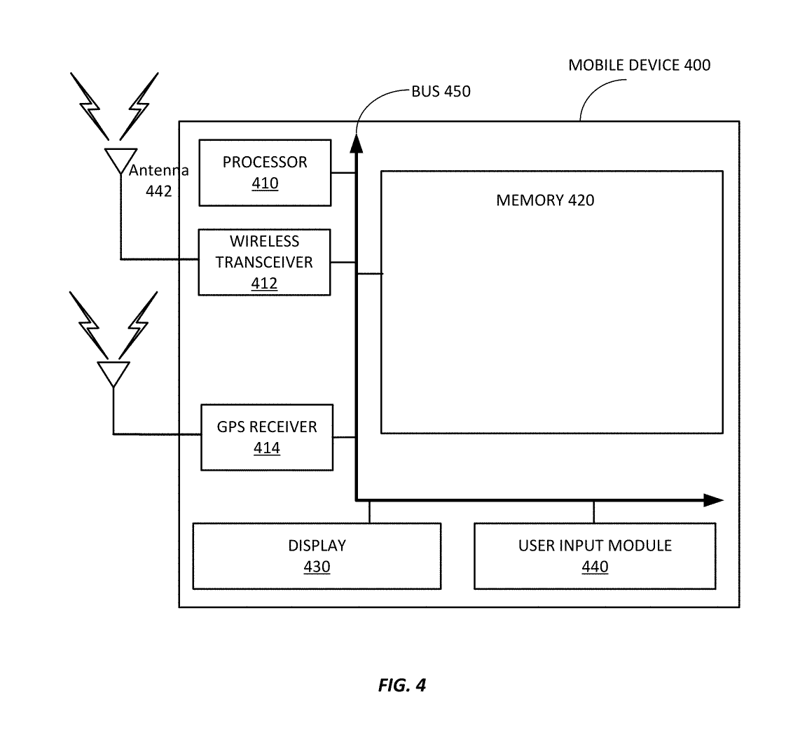

Referring now to FIG. 4, FIG. 4 shows an example mobile wireless device 400 suitable for adaptive wake-up scheduling under PRS muting. In the example shown in FIG. 4, the mobile device includes a processor 410, a memory 420, a wireless transceiver 412, a Global Navigation Satellite System (“GNSS”) 414, such as a Global Positioning System (“GPS”) receiver, a display 430, a user input module 440, and a bus 450. In this example, the mobile device 400 is a cellular smartphone, but may be any suitable device, include a cellular phone, a laptop computer, a tablet, a phablet, a personal digital assistant (“PDA”), wearable device, or augmented reality device. The processor 410 employs bus 450 to execute program code stored in memory 420, to output display signals to a display 430, and to receive input from the user input module 440. In addition, the processor 410 is configured to receive information from the GPS receiver 414 and wireless transceiver 412 and to transmit information to the wireless transceiver 412.

The wireless transceiver 412 is configured to transmit and receive wireless signals via antenna 442 using link 444. For example, the wireless transceiver may be configured to communicate with a cellular base station by transmitting signals to and receiving signals from an antenna associated with the cellular base station. In addition, the transceiver 412 can receive PRS broadcast by one or more cellular transmitters and provide information about each received PRS to the processor 410 to be used for OTDOA or other location techniques.

The GPS receiver 414 receives signals from one or more GPS satellites and to provide location signals to the processor 410. And while this example employs a GPS receiver, any suitable GNSS receiver or receivers may be employed in different examples. Further, it should be appreciated that various implementation options may be available in accordance with specific power or accuracy targets in various applications. For example, a customized hardware in the same wafer or die of the silicon sensor might also be used, or particular elements might be implemented in customized hardware, software or both, to replace the processor in the FIG. 4.

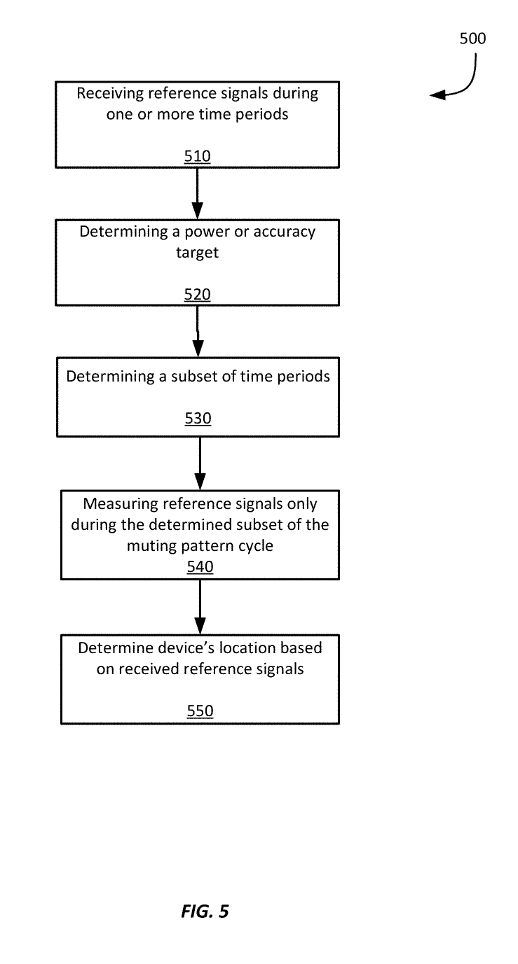

Referring now to FIG. 5, FIG. 5 shows an example method 500 for adaptive wake-up scheduling under PRS muting. The description of the example method 500 below will be made with reference to the mobile device shown in FIG. 4 and the PRS muting cycle 200 shown in FIG. 2; however, it should be understood that any suitable environment, PRS muting cycle, or mobile device may be employed according to different examples.

At block 510, the mobile device 110 receives, during one or more evaluation time periods within a muting pattern cycle 200, reference signals detectable by the mobile device 400 during the one or more evaluation time periods within the muting pattern cycle. In this example, the mobile device 400 performs a PRS evaluation scan by waking up and receiving PRS broadcast from cellular transmitters during each time period of the PRS muting cycle 200. In this example, the mobile device 400 stays “awake” during all time periods of a single PRS muting cycle 200, thereby more quickly obtaining PRS measurements for each cellular transmitter detectable by the mobile device 400. The cellular transmitters, in this example, transmit 3GPP LTE PRS; however, in some examples, other types of PRS may be transmitted.

However, in some examples of performing block 510, the mobile device 400 may only wake up for a subset of the time periods of any iteration of the PRS muting cycle 200. For example, the mobile device 400 may wake up during time periods 1 and 4 of a first iteration of the PRS muting cycle 200, then during time periods 2 and 5 of the next iteration, and so forth, until PRS on all time periods have been received.

After receiving the PRS signals, the mobile device 400 performs measurements based on the received PRS. In this example, the mobile device performs Reference Signal Time Difference (“RTSD”) measurements according to 3GPP Technical Specification (“TS”) 36.214 to perform OTDOA positioning; however, in other examples, other measurement techniques may be employed. In this example, the RTSD indicates a relative timing difference between two cells, a reference cell and the measured cell, based on the smallest time difference between two subframe boundaries received from the two different cells.

In some examples, the mobile device 400 may perform multiple evaluation scans or perform multiple measurements of each time period of the PRS muting cycle. Such measurements may be performed on consecutive iterations of a PRS muting cycle, or may be performed periodically over time. For example, the mobile device 400 may measure PRS every 5 minutes, or after an event, such as handover to a new cellular transmitter or after the mobile device is first powered on, after awaking from a sleep mode, or following a loss of signal from a GNSS satellite.

In some examples, the mobile device 400 may return to block 510 periodically based on a detected movement of the mobile device 400. For example, the mobile device 400 may receive sensor signals, e.g., from an accelerometer, indicating movement of the mobile device 400. From such sensor signals, the mobile device 400 may estimate a speed or velocity of the mobile device 400, e.g., based on a walking speed or stride length of the user of the mobile device 400, and after a reference distance has been travelled, the mobile device 400 may perform a new PRS evaluation scan at block 510. For example, the reference distance can indicate that the signaling environment for the mobile device 400 has changed significantly and that new evaluation of the signals received according to the muting pattern cycle is appropriate. Hence, the receiving, by the mobile device 400 reference signals, and subsequent measurement of the received signals, during the one or more evaluation time periods discussed above may be repeated as appropriate. Means for performing the functions described above with reference to block 510 include, for example, the processor 410 and the wireless transceiver 412. In some examples, the processor 410 may execute processor-executable instructions stored in memory 420 to activate the wireless transceiver 412 at a time corresponding to one or more PRS signals and configure the wireless transceiver 412 to receive such one or more PRS signals using the antenna 442. The processor 410 may then receive information from the transceiver corresponding to one or more received PRS signals

At block 520, the mobile device 400 optionally determines a power or accuracy target for a location determination. In one example, an application executing on the mobile device 400 transmits a request for a location to a location service executed by the mobile device 400. In this example, the request includes an indication of an accuracy target for the location. An indication of an accuracy target may be an acceptable error in a location, e.g., within 20 meters, or may be a relative accuracy target. For example, the location service executed by the mobile device may define one or more levels of accuracy available for a location request, such as low accuracy, medium accuracy, high accuracy, and highest accuracy. Thus, a request from the application may indicate one of the levels of accuracy.

In some examples, the application may not provide an indication of an accuracy target, but may instead infer an accuracy target. For example, a mobile device may associate a maximum accuracy target with a request received from an emergency service, such as a designated emergency phone number (e.g., 911 or 999). In contrast, a location request from a social media application, e.g., Facebook or Instagram, may be associated with a low accuracy target. Similarly, a location request from a navigation application may be associated with a high accuracy target.

As discussed above, a mobile device may determine a power consumption target associated with a location request. Such a power consumption target may be based on a current battery level or current power consumption rate by the mobile device. In some examples, however, the power consumption target may be associated with a volume of location requests received from an application over time. For example, a social media application may issue location requests at a relatively short interval, e.g., every minute, which may result in significant power consumption if the mobile device were to wake up for each time period in a PRS muting cycle. Thus, the mobile device 400 may determine a power consumption target based on a volume of requests. Further, in some examples, an application may provide an explicit indication of a power consumption target for a location determination. Means for performing the functions described above with reference to block 520 include, for example, the processor 410, which may execute processor-executable instructions stored in memory 420 to access one or more configurations, e.g., from a memory 420 or a configuration file.

At block 530, the mobile device 400 may determine a subset of time periods within the PRS muting cycle. The subset that is determined can then be used for measuring reference signals to compute a location for the mobile device 400. By use of the term “subset,” it is understood that the subset of the muting pattern cycle comprises a number of time periods that is fewer than the two or more time periods of the muting pattern cycle. In one example, the subset of time periods within the PRS muting cycle is determined based on a quality of the measured reference signals. In this example, the mobile device 400 ranks the detected cellular transmitters based on a corresponding quality of the received PRS from the respective cellular transmitter. In some examples, the mobile device 400 may also eliminate from consideration any cellular transmitter below a reference quality threshold. Although block 520 is shown occurring before block 530 for this example, it is understood that block 530 may occur before block 520.

In this example, the mobile device 400 maintains a data structure, e.g., a table, correlating a number of time periods with a location accuracy or a power consumption. For example, as discussed above, the correlation may indicate two cellular transmitters to use for low accuracy location determination, four cellular transmitters to use for medium accuracy location determination, twelve cellular transmitters to use for high-accuracy location determination, and sixteen cellular transmitters to use for highest-accuracy location determination.

In some examples, after determining a location accuracy or power consumption target, the mobile device 400 selects a number of time periods of the PRS muting cycle during which to wake up and receive PRS signals. As discussed above, a number of time periods may be maintained in a data structure, thus the mobile device may access the data structure to determine the number of time periods. The mobile device may then select one or more time periods based on the quality of the measured reference signals. For example, after selecting a number of time periods, e.g., N time periods time periods, based on the location accuracy target or the power consumption target, the mobile device 400 may then determine the subset of the muting pattern cycle for measuring reference signals, for example, the N cellular transmitters with the highest quality measurements, irrespective of overlap within particular time periods. Hence, in implementations where the number of time periods to measure is determined first, the subset of the muting pattern cycle can be determined, at least in part, on the number and on another factor, such as the quality of measurements associated with the subset. However, in some examples, the mobile device 400 may select cellular transmitters to minimize the number of time periods during which to wake.

In one example, the mobile device 400 determines that four PRS measurements are to be performed for a location accuracy target. The mobile device 400 may then select a time period in the PRS muting cycle 200 corresponding to the cellular transmitter having highest-quality PRS. The mobile device 400 may then search for additional nearby cellular transmitters also transmitting PRS during the selected time period. If one or more is discovered, the mobile device 400 may also identify one or more of those discovered cellular transmitters as candidates from which to obtain PRS measurements. Thus, the mobile device 400 may select multiple cellular transmitters from which to concurrently receive PRS or it may receive multiple PRS from a single cellular transmitter (or even multiple cellular transmitters) over multiple time periods. The mobile device 400 proceeds accordingly until a number of cellular transmitters and time periods has been selected during which the mobile device 400 wake up and listen for PRS.

In some examples, however, the mobile device 400 may select time periods based on parameters other than, or in addition to, a quality metric. Selecting PRS sources in directions covering a wider arc around the mobile device 400 may provide more useful information to determine the mobile device's location than three high quality PRS sources that are generally in the same direction from the mobile device 400.

For example, referring to FIG. 1, if PRS sources 120c-e have the highest quality scores of the available PRS sources, the mobile device 110 may nevertheless select PRS sources 120c, 120e, and 120h, where PRS source 120h has a lower quality score, but is located at a geographically diverse location from PRS sources 120c, 120d which are located along approximately the same vector from the mobile device 110. Such geographical diversity may provide more useful information when determining the mobile device's location in some examples.

To determine one or more PRS sources based on geographical diversity, the mobile device 400 may determine a direction to each of one or more PRS source candidates based on an accuracy or location target. The mobile device 400 may then select a highest-quality PRS source and then determine a score for the next N highest-quality PRS sources and weight each of the sources based on geographic diversity from the selected highest-quality PRS source. Such weighting may be based on an angle between a direction to the selected highest-quality PRS source and a respective one of the next N highest-quality PRS sources.

A preferred geographic diversity may vary based on a number of PRS sources to be measured based on a location accuracy or power consumption target. For example if a location accuracy or power consumption target indicates three PRS sources are to be used, a preferred geographic diversity may include three PRS sources equally spaced around the mobile device 400 at angles of 120 degrees from the adjacent PRS sources. In a case where six PRS sources are to be used, a preferred geographic diversity may include PRS sources equally spaced around the mobile device 400 at angles of 60 degrees from the adjacent PRS sources. While such exact spacing may not be available in all scenarios, a mobile device 400 may select one or more PRS sources to approximate such geographic diversity parameters. It should be appreciated, however, that other geographic diversity parameters may be employed in different examples. As shown in the examples above, when determining a subset of the muting pattern cycle for measuring reference signals, the mobile device may make such a determination based on a quality of the measured reference signals, a geographic diversity of candidate reference signal sources, a power consumption target, a location accuracy target, or any combination thereof. Means for performing the functions described above with reference to block 530 include the processor 410 of the mobile device 400 executing processor-executable instructions stored in memory 420 to perform the function(s) discussed above with respect to block 530.

At block 540, the mobile device 400 receives and measures reference signals only during the time periods of the subset of the muting pattern cycle determined in block 530. In one example, the mobile device 400 wakes up during the selected time periods of the PRS muting cycle 200, receives PRS from one or more cellular transmitters, and sleeps (thereby not receiving PRS) during non-selected time periods. As discussed above, by only waking up during certain time periods, and sleeping through the others, the mobile device 400 is able to reduce its power consumption while still obtaining enough information for determining its location within the accuracy targets of a particular application. In one example, the mobile device 400 performs measurements on the received PRS, such as performing RTSD measurements as described above. Means for performing the functions described above with reference to block 540 include the wireless transceiver 412 or the processor 410 of the mobile device shown in FIG. 4. For example, the processor 410 may execute processor-executable instructions stored in memory 420 to enable the wireless transceiver 412 to receive PRS from one or more cellular transmitters using antenna 442. The wireless transceiver 412 may then receive such PRS and provide to the processor 410 information related to the received signals. In some examples, the wireless transceiver 412 may perform one or more of the measurements of the received PRS, or may provide information to the processor 410 to enable the processor 410 to perform one or more measurements of the received PRS.

At block 550, after performing the measurements, the mobile device 400 location is determined based on the reference signals measured during the determined subset of the muting pattern cycle. In one example, the mobile device 400 transmits them to a remote device (which is configured to determine a location of the mobile device based on the reference signals measured during the determined subset of the muting pattern cycle), such as a cellular network device, which determines the mobile device's location based on the measurements, and transmits the determined location back to the mobile device 400. In some examples, however, rather than transmitting the measured received signals to a remote device, the mobile device 400 determines its location based on the measurements. Means for performing the functions described above with reference to block 550 include the processor 410 of the mobile device 400 shown in FIG. 4, or may include, for example, one or more components of the PRS assistance system 310 shown in FIG. 3, such as one or more servers 312, executing processor-executable instructions stored in memory 420 to perform the function(s) discussed above with respect to block 550.

It should be appreciated that while the steps of the method 500 shown in FIG. 5 are illustrated and described in a particular order, no particular order is required. For example, block 520 may be performed before block 510. Still further variations of the orderings of the method 500 are contemplated within the scope of this disclosure.

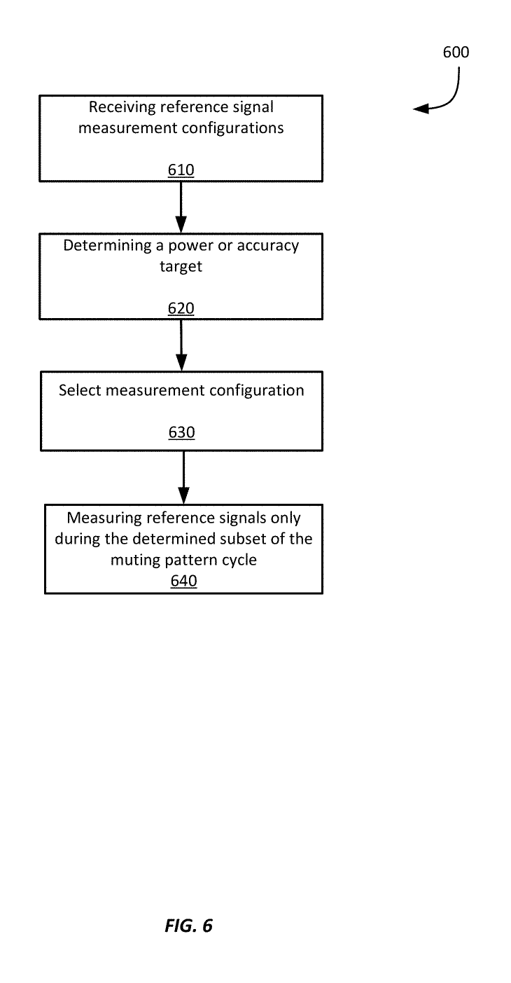

Referring now to FIG. 6, FIG. 6 shows an example method 600 for adaptive wake-up scheduling under PRS muting. The description of the example method 600 below will be made with reference to the mobile device shown in FIG. 4 and the PRS muting cycle 200 shown in FIG. 2; however, it should be understood that any suitable environment, PRS muting cycle, or mobile device may be employed according to different examples.

At block 610, the mobile device 400 receives one or more reference signal measurement configurations for a muting pattern cycle. In this example, the mobile device 400 receives a configuration from a PRS assistance system 310 that includes information regarding available PRS, corresponding time periods, and qualities of one or more of the PRS. It is understood that the configuration can be geographically dependent and that based on the rough location of the mobile device 400 at any given time, the reference signal measurement configuration(s) can change. The reference signal measurement configuration(s) can therefore be updated when the mobile device 400 is in a different location. For example, referring to the PRS muting cycle 200 shown in FIGS. 2A and 2B, the configuration includes the following, where ‘Quality’ has value ranging from 0 (worst) to 10 (best):

TABLE 1

| PRS | Time | |
|---|---|---|
| Source | Period | Quality |
| 1 | 5 | 9 |
| 2 | 2 | 10 |
| 3 | 6 | 3 |
| 4 | 3 | 2 |
| 5 | 4 | 6 |
| 6 | 6 | 1 |
| 7 | 2 | 6 |
| 8 | 1 | 7 |
| 9 | 4 | 4 |
| 10 | 7 | 9 |
| 11 | 2 | 8 |
| 12 | 6 | 3 |
| 13 | 8 | 4 |
| 14 | 1 | 5 |
| 15 | 5 | 2 |
| 16 | 8 | 3 |

Such configuration information may enable the mobile device 400 to use the configuration information rather than perform a PRS evaluation scan, thereby reducing power consumption associated with PRS evaluation scans. At a later time when selecting one or more PRS sources to receive (by, for example, awakening from a standby or sleep mode in order to receive) and measure, the mobile device 400 can access the data structure and, based on an accuracy or power consumption target, select appropriate PRS sources. While the example shown above includes a “quality” metric, other examples may include other or additional metrics, such as a priority metric, a direction vector from a location to the PRS signal source (to allow for selecting a subset of the muting pattern cycle based on geographic diversity, for example), a distance to the PRS signal source (possibly for geographic diversity or other reasons, for example), or others. Such information may be employed by the mobile device 400 when selecting one or more PRS sources to measure as will be described in more detail below.

In some examples, a priority (or priority metric) of a time period may be modified by the mobile device. For example, if while attempting to receive PRS during a time period, the mobile does not detect PRS, the mobile device may determine that no detectable PRS signal is available in that time period, and reduce a priority of the time period, e.g., by setting it to a minimum value or by decrementing an associated priority. In some examples, the mobile device may instead, detect one or more strong PRS during a time period and may increase a priority of the time period, which may allow the time period to be selected in favor of another time period. And while, in some examples, a priority for a time period may be reduced or increased during a particular evaluation scan, or while the mobile device is determining its location, such a change in priority may be temporary. For example, a changed priority may be maintained for a predetermined period of time, or only while the mobile device is within a particular area. Further, in some examples, when a mobile device is performing an evaluation scan, it may reset priorities for time periods prior to the evaluation scan.

In some examples, reference signal measurement configurations may instead include multiple configurations, each associated with an accuracy or power consumption target. For example, the PRS assistance system 310 may transmit separate reference signal measurement configurations for different accuracy or power consumption target. For example, the PRS assistance system 310 may transmit four separate reference signal measurement configurations, one each corresponding to four different accuracy targets: (1) low accuracy (e.g., 30-50 meters (m)), (2) moderate accuracy (20-30 m), (3) high accuracy (10-20 m), and (4) highest accuracy (<10 m). Each configuration may include PRS sources to use and corresponding time periods.

In some examples, the PRS assistance system 310 may transmit reference signal measurement configurations based on power consumption targets rather than accuracy targets, or each configuration may be applicable to both a corresponding accuracy and power consumption target. For example, the PRS assistance system 310 may transmit four configurations, one each for levels corresponding to low, moderate, high, and highest, with each level equally-applicable to power consumption and location accuracy. In some examples, however, different numbers or types of configurations may be provided for location accuracy or power consumption, or one or more configurations may be provided corresponding to power consumption and location accuracy, e.g., low power, moderate accuracy.

In some examples, the PRS assistance system 310 may transmit multiple types of reference signal measurement configurations. For example, the PRS assistance system 310 may send reference signal measurement configurations both for accuracy and power. Further, in some examples, may send multiple configurations for each of the types. For example, the PRS assistance system 310 may send up to four reference signal measurement configurations each for accuracy and power. In some examples, the PRS assistance system 310 may send a configuration for either or both of high accuracy or high power and a configuration for either or both of a low accuracy or low power. One such example may enable a mobile device to select an appropriate reference signal measurement configuration based on one or more targets for accuracy or power.

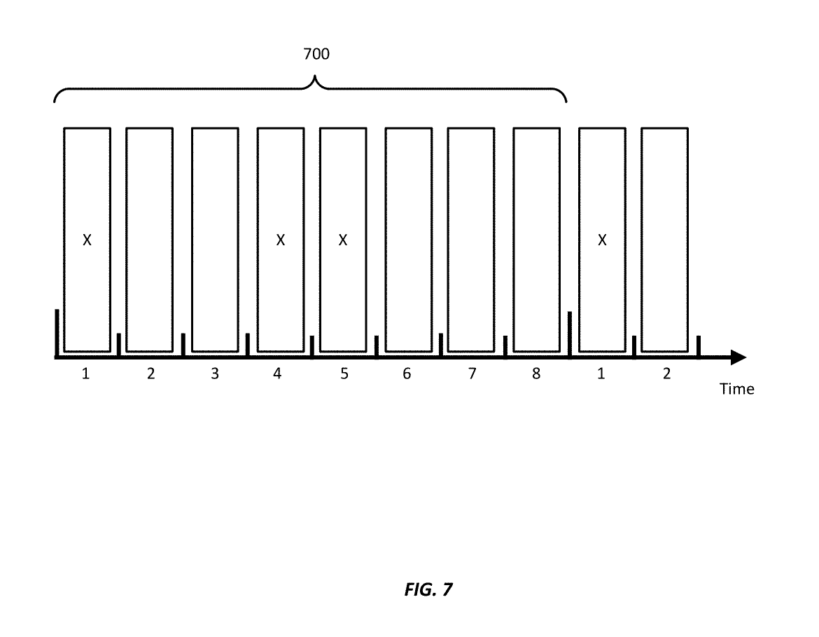

While the examples above relate to selecting PRS sources, in some examples, a reference signal measurement configurations may comprise information indicating which time periods during which to receive and measure PRS. Referring to FIG. 7, FIG. 7 illustrates a graphical representation of a reference signal measurement configuration that specifies time periods during which to receive PRS—indicated by an “X” in the respective time period—and time periods during which to remain idle. In this example, the reference signal measurement configuration indicates that PRS is to be received during time periods 1, 4, and 5 only; however, it should be appreciated that any combination of time periods may be specified in a reference signal measurement configuration. Further, as discussed above, a mobile device 400 may receive multiple reference signal measurement configurations indicating different time periods during which to receive PRS, such as based on differing location accuracy or power consumption targets.

In some examples, a reference signal measurement configurations may comprise a bit field indicating which time periods of a PRS muting cycle during which to receive PRS. For example, the 8 least-significant bits of a bit field corresponding to the reference signal measurement configuration of FIG. 7 may comprise 0x00011001, where time period 1 is represented at bit position 0. It should be appreciated that the width of a bit field may vary based on the number of time periods within a PRS muting cycle. Means for performing the functions described above with reference to block 610 include X, Y, and/or Z.

At block 620, the mobile device 400 optionally determines a power consumption or accuracy target generally as discussed above with respect to block 520. Means for performing the functions described above with reference to block 620 include, for example, the processor 410 and the wireless transceiver 412. In some examples, the processor 410 may execute processor-executable instructions stored in memory 420 to activate the wireless transceiver 412 at a time corresponding to one or more PRS signals and configure the wireless transceiver 412 to receive such one or more PRS signals using the antenna 442. The processor 410 may then receive information from the transceiver 412 corresponding to one or more received PRS signals.

At block 630, the mobile device 400 selects a reference signal measurement configuration based on the determined power consumption or accuracy target. In this example, the mobile device 400 selects and accesses the reference signal measurement configuration shown in Table 1 and discussed above with respect to block 610. In addition, optionally, the mobile device 400 uses the determined power consumption or accuracy target to select one or more PRS sources from the configuration. For example, a moderate accuracy target may indicate that 6 PRS sources should be measured. The mobile device 400 may then select 6 PRS sources from the configuration.

In this example, the mobile device 400 selects the PRS sources having the 6 highest quality scores, which are, in order, PRS sources 2, 1, 10, 11, 8, and 7. In some examples, the mobile device 400 may select PRS sources based on quality or other metrics. For example, the mobile device 400 may select one or more PRS sources based on quality and a direction to the respective PRS source, such as the geographical diversity metric described above with respect to block 530 of FIG. 5.

While in this example, a reference signal measurement configuration is received from the PRS assistance system 310, measurement configurations may be generated by the mobile device 400 itself. Hence, a reference signal measurement configuration may be obtained either by the mobile device itself, as shown, for example, in the method 500 of FIG. 5 which includes performing a PRS evaluation scan, which may provide information regarding PRS sources. The mobile device may then select a measurement configuration based on the results of the PRS evaluation scan, or may update the quality parameters within the received reference signal measurement configuration based on the results of the PRS evaluation scan. In some examples, the mobile device 400 may also transmit the results of the PRS evaluation scan to the PRS assistance system 310 to enable it to update its assistance information. Hence, the signal measurement configurations generated by the server for sending to mobile devices can be, in one example, crowdsourced from information received from a plurality of mobile devices. Means for performing the functions described above with reference to block 630 include the processor 410 of the mobile device 400 shown in FIG. 4 executing processor-executable instructions stored in memory 420 to perform the function(s) discussed above with respect to block 630.

At block 640, the mobile device 400 measures reference signals only during the subset of the muting pattern cycle, where the subset of the muting pattern cycle is selected or determined based on the received signal measurement configuration, as discussed above with respect to block 540 of FIG. 5. Means for performing the functions described above with reference to block 640 include the wireless transceiver 412 or the processor 410 of the mobile device shown in FIG. 4. For example, the processor 410 may execute processor-executable instructions to enable the wireless transceiver 412 to receive PRS from one or more cellular transmitters. The wireless transceiver 412 may then receive such PRS and provide to the processor 410 information related to the received signals. In some examples, the wireless transceiver 412 may perform one or more of the measurements of the received PRS, or may provide information to the processor 410 to enable the processor 410 to perform one or more measurements of the received PRS.

It should be appreciated that while the steps of the method 600 shown in FIG. 6 are illustrated and described in a particular order, no particular order is required. For example, block 620 may be performed before block 610. Further, block 630 may be performed prior to blocks 610 or 620, e.g., based on a default configuration or a previously received measurement configuration. Still further variations of the orderings of the method 500 are contemplated within the scope of this disclosure.

It should also be appreciated that aspects of the method 500 of FIG. 5 may be incorporated into the method 600 of FIG. 6, or aspects of the method 500 of FIG. 6 may be incorporated into the method 600 of FIG. 5. For example, a mobile device 400 may perform the method 600 of FIG. 6, but may also perform a PRS evaluation scan. Such a scan may be employed to verify or correct information received from the PRS assistance system 310, or to provide feedback information to the PRS assistance system.

While the methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs for adaptive wake-up scheduling under PRS muting. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein including, for example, one or more block depicted in FIGS. 5 and 6.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

What is claimed is:

1. A method for measuring, by a mobile device, a plurality of reference signals for positioning having a muting pattern cycle comprising two or more time periods, the method comprising:
receiving, by the mobile device, during one or more evaluation time periods within a muting pattern cycle, reference signals detectable by the mobile device during the one or more evaluation time periods within the muting pattern cycle;
determining a subset of the muting pattern cycle for measuring reference signals, wherein the subset of the muting pattern cycle comprises a number of time periods fewer than the two or more time periods of the muting pattern cycle; and
measuring, by the mobile device, reference signals only during the determined subset of the muting pattern cycle.

2. The method of claim 1, further comprising, determining a location of the mobile device based on the reference signals measured during the determined subset of the muting pattern cycle.

3. The method of claim 1, further comprising:
transmitting one or more of the references signals measured during the determined subset of the muting pattern cycle to a remote device, the remote device configured to determine a location of the mobile device based on the reference signals measured during the determined subset of the muting pattern cycle; and
receiving the location of the mobile device.

4. The method of claim 1, wherein the determining the subset of the muting pattern cycle for measuring reference signals comprises determining the subset based on a quality of the measured reference signals, a geographic diversity of candidate reference signal sources, a power consumption target, a location accuracy target, or any combination thereof.

5. The method of claim 4, wherein the determined subset of the muting pattern cycle is based on a power consumption target or a location accuracy target, the method further comprising:
receiving the power consumption target or the location accuracy target for the location measurement; and
determining the number of time periods for the subset of the muting pattern cycle based on the power consumption target or location accuracy target, wherein determining the subset of the muting pattern cycle is based, at least in part, on the number.

6. The method of claim 5, wherein the determined subset of the muting pattern cycle is based on a priority of the time periods of the muting pattern cycle.

7. The method of claim 1, further comprising:
determining a no-signal-detected subset of the muting pattern cycle having no detectable reference signal; and
reducing a priority of time periods in the no-signal detected subset of the muting pattern cycle.

8. A device for measuring a plurality of reference signals for positioning having a muting pattern cycle comprising two or more timeslots comprising:
a non-transitory computer-readable medium storing processor-executable instructions;
a processor in communication with the non-transitory computer-readable medium, the processor configured to execute the processor-executable program code to:
receive, by a mobile device, during one or more evaluation time periods within a muting pattern cycle having two or more time periods, reference signals detectable by the mobile device during the one or more evaluation time periods within the muting pattern cycle;
determine a subset of the muting pattern cycle for measuring reference signals, wherein the subset of the muting pattern cycle comprises a number of time periods fewer than the two or more time periods of the muting pattern cycle; and
measuring, by the mobile device, reference signals only during the determined subset of the muting cycle.

9. The device of claim 8, wherein processor-executable program code is further configured to cause the processor to:
transmit one or more of the reference signals measured during the determined subset of the muting pattern cycle to a remote device, the remote device configured to determine a location of the mobile device based on the reference signals measured during the determined subset of the muting pattern cycle; and
receive the location of the mobile device.

10. The device of claim 8, wherein the processor-executable program code is further configured to cause the processor to determine the subset based on a quality of the measured reference signals, a geographic diversity of candidate reference signal sources, a power consumption target, a location accuracy target, or any combination thereof.

11. The device of claim 10, wherein the determined subset of the muting pattern cycle is based on a power consumption target or a location accuracy target for a location measurement, and wherein the processor-executable program code is further configured to cause the processor to:
receive the power consumption target or the location accuracy target for the location measurement; and
determine the number of time periods for the subset of the muting pattern cycle based on the power consumption target or location accuracy target, wherein determining the subset of the muting pattern cycle is based, at least in part, on the number.

12. The device of claim 10, wherein the determined subset of the muting pattern cycle is based on a priority of the time periods of the muting pattern cycle.

13. The device of claim 8, wherein processor-executable program code is further configured to cause the processor to:
determine a no-signal-detected subset of the muting pattern cycle having no detectable reference signal; and
reduce a priority of time periods in the no-signal-detected subset of the muting pattern cycle.

14. A non-transitory computer-readable medium storing processor-executable instructions configured to cause a processor to:
receive, by a mobile device, during one or more time evaluation periods within a muting pattern cycle having two or more time periods, reference signals detectable by the mobile device during the one or more time evaluation periods within the muting pattern cycle;
determine a subset of the muting pattern cycle for measuring reference signals, wherein the subset of the muting pattern cycle comprises a number of time periods fewer than the two or more time periods of the muting pattern cycle; and
measure, by the mobile device, reference signals only during the determined subset of the muting pattern cycle.

15. The non-transitory computer-readable medium of claim 14, wherein processor-executable program code is further configured to:
transmit one or more of the reference signals measured during the determined subset of the muting pattern cycle to a remote device, the remote device configured to determine a location of the mobile device based on the reference signals measured during the determined subset of the muting pattern cycle; and
receive the location of the mobile device.

16. The non-transitory computer-readable medium of claim 14, wherein the processor-executable program code is further configured to cause the processor to determine the subset based on a quality of the measured reference signals, a geographic diversity of candidate reference signal sources, a power consumption target, a location accuracy target, or any combination thereof

17. The non-transitory computer-readable medium of claim 16, wherein the determined subset of the muting pattern cycle is based on a power consumption target or a location accuracy target for a location measurement, and wherein processor-executable program code is further configured to cause the processor to:
receive the power consumption target or the location accuracy target; and
determine the number of time periods for the subset of the muting pattern cycle based on the power consumption target or location accuracy target, wherein determining the subset of the muting pattern cycle is based, at least in part, on the number.

18. The non-transitory computer-readable medium of claim 17, wherein the determined subset of the muting pattern cycle is based on a priority of the time periods of the muting pattern cycle.

19. The non-transitory computer-readable medium of claim 14, wherein processor-executable program code is further configured to cause the processor to:
determine a no-signal-detected subset of the muting pattern cycle having no detectable reference signal; and
reduce a priority of time periods in the no-signal-detected subset of the muting pattern cycle.

20. An apparatus for measuring a plurality of reference signals for positioning having a muting pattern cycle comprising two or more timeslots, the apparatus comprising:
means for receiving, during one or more evaluation time periods within a muting pattern cycle, reference signals detectable by the mobile device during the one or more evaluation time periods of the set of time periods within the muting pattern cycle;
means for determining a subset of the muting pattern cycle for measuring reference signals, wherein the subset of the muting pattern cycle comprises a number of time periods fewer than the two or more time periods of the muting pattern cycle; and
means for measuring reference signals only during the determined subset of the muting pattern cycle.

21. The apparatus of claim 20, further comprising:
means for transmitting one or more of the references signals measured during the determined subset of the muting pattern cycle to a remote device, the remote device configured to determine a location of the mobile device based on the reference signals measured during the determined subset of the muting pattern cycle; and
means for receiving the location of the mobile device.

22. The apparatus of claim 20, further comprising means for determining the subset based on a quality of the measured reference signals, a geographic diversity of candidate reference signal sources, a power consumption target, a location accuracy target, or any combination thereof.

23. The apparatus of claim 22, wherein the determined subset of the muting pattern cycle is based on a power consumption target or a location accuracy target for a location measurement, and further comprising:
means for receiving the power consumption target or the location accuracy target for a location measurement; and
means for determining the number of time periods for the subset of the muting pattern cycle based on the power consumption target or location accuracy target, wherein determining the subset of the muting pattern cycle is based, at least in part, on the number.

24. The apparatus of claim 23, wherein the determined subset of the muting pattern cycle is based on a priority of the time periods of the muting pattern cycle.

25. The apparatus of claim 20, further comprising:
means for determining a no-signal-detected subset of the muting pattern cycle having no detectable reference signal; and
means for reducing a priority of time periods in the no-signal-detected subset of the muting pattern cycle.
